(19) United States
(12) Patent Application Publication
(10) Pub. No.: US 2019/0070751 A1
(43) Pub. Date: Mar. 7, 2019

(54) SLICING METHOD AND A SLICING APPARATUS FOR AN INGOT

(71) Applicant: ZING SEMICONDUCTOR CORPORATION, Shanghai (CN)

(72) Inventors: YAN WANG, Shanghai (CN); YUAN LIU, Shanghai (CN)

(21) Appl. No.: 16/109,912

(22) Filed: Aug. 23, 2018

(30) Foreign Application Priority Data
Sep. 5, 2017 (CN) 201710792762.3

(51) Int. Cl. B28D 5/00; B28D 5/04

(52) U.S. Cl. CPC B28D 5/0076; B28D 5/0082; B28D 5/042

(57) ABSTRACT

A slicing method and a slicing apparatus for an ingot are provided. The slicing method for the ingot comprises: setting an ingot on an ingot-feeding device; descending the ingot by the ingot-feeding device and loosening a diamond wire synchronously such that the ingot is surrounded with the diamond wire; and tightening the diamond wire to begin to slice after the ingot is descended to a cooling tank. The slicing method and the slicing apparatus for the ingot of the present disclosure could raise the slicing speed and reduce the temperature difference from a slicing area to a non-slicing area so that the wrap of a silicon chip is improved.

### INCORPORATION BY REFERENCE

This application claims priority from China Patent Application No. 201710792762.3, filed on Sep. 5, 2017, the contents of which are hereby incorporated by reference in their entirety for all purposes.

### TECHNICAL FIELD

The present disclosure relates a semiconductor manufacturing technology, and particularly, relates to a slicing method and a slicing apparatus for an ingot.

### BACKGROUND

In the process of fabricating a silicon wafer, a monocrystalline ingot should be sliced to a thin wafer with the precise thickness, which generally determines the scale of the warp of the wafer and also affects the efficiency of the following process significantly. In the earlier slicing process for a small-size wafer, an inner diameter cutting machine was used a processing machine. However, along with the scale of the wafer extends to 300 mm, the inner diameter cutting machine has been replaced by a wire cutting machine, which is widely applied in the ingot slicing process.

In particularly, the wire cutting is divided to adopting the steel wire cutting and the diamond wire cutting. Through the steel wire feeding, the steel wire cutting uses mortar (high rigidity SiC+polyethyleneglycol) as the grinding medium to slice the ingot. The advantage of this method is the warp of the wafer is better controlled. However, the slicing efficiency is lower and the steel wire couldn't be reused.

The diamond wire cutting adopts depositing the diamond particles on the steel wire surface by the consolidation method to slice the ingot, in which the diamond particles are used as the grinding medium. The advantages of this method are the slicing efficiency is high and the diamond wire is reusable. However, since the severe rubbing between the diamond particles and the ingot during slicing, the temperature gradient between a slicing area and a non-slicing area of the ingot is larger, such that the warp the wafer is worse.

Accordingly, a slicing method and a slicing apparatus for an ingot are required to solve the above-mentioned problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

For above mentioned problems, the present disclosure provides a slicing method for an ingot. The method includes the following steps: setting an ingot on an ingot-feeding device; descending the ingot by the ingot-feeding device and loosening a diamond wire synchronously such that the ingot is surrounded with the diamond wire; and tightening the diamond wire after the ingot is descended to a cooling tank to begin to slice the ingot.

In one aspect, loosening or tightening the diamond wire is controlled by a movement of a movable roller.

In another aspect, the method further comprises the step of wrapping a resin layer around the ingot.

In yet another aspect, in the process of slicing the resin layer, the slicing speed is increased gradually.

In still another aspect, at the beginning of slicing the resin layer, an intake port and a delivery port of the cooling tank are opened such that the cooling fluid is circulated in the cooling tank.

In still another aspect, at the beginning of slicing the ingot, the circulated speed of the cooling fluid in the cooling tank is increased.

In an exemplary embodiment, a slicing apparatus for an ingot is provided. The apparatus comprises: an ingot-feeding device operable to control an ingot to move in a vertical direction; a diamond wire disposed below the ingot-feeding device and provided with a movable roller operable to control the diamond wire to be loosened or tightened; and a cooling tank disposed below the diamond wire and operable to cooling the ingot in the process of slicing the ingot.

In one aspect, the apparatus further comprises a wire guiding wheel disposed above the cooling tank and operable to control a reciprocal movement of the diamond wire.

In another aspect, the cooling tank comprises an intake port at an under side thereof and a delivery port at a bottom side thereof.

The slicing method and the slicing apparatus for the ingot of the present disclosure could raise the slicing speed and reduce the temperature difference from a slicing area to a non-slicing area so that the wrap of a silicon chip is improved.

### BRIEF DESCRIPTION OF THE DRAWINGS

Exemplary embodiments will be more readily understood from the following detailed description when read in conjunction with the appended drawing, in which:

FIGS. 1A through 1B are schematic views illustrating a slicing method for an ingot according to one embodiment of the present disclosure;

FIG. 2. is a process flow chart of a slicing method for an ingot according to one embodiment of the present disclosure; and

FIGS. 3 through 6B are schematic views of the slicing apparatus in sequential steps of the method.

### DETAILED DESCRIPTION

In the following detailed description of various embodiments in accordance with the invention, numerous specific details are set forth in order to provide a thorough understanding of the invention. However, it will be evident to one of ordinary skill in the art that the present invention may be practiced without some of these specifically described details. For focus, clarity and brevity, as well as to avoid unnecessarily occluding, obscuring, obstructing or obfuscating features that may be somewhat more germane to or significant in explaining example embodiments of the present invention, this description may avoid describing some well-known technical feature in exhaustive detail.

It should be understood that the present invention can be embodied in various forms and should not be construed as being limited to the embodiments set forth herein. Rather, these embodiments are provided so that this disclosure will be thorough and complete, and will fully convey the scope of the invention to those skilled in the art. In the drawings, the size of layers and regions, and relative sizes may be exaggerated for clarity. The same reference numerals refer to the same elements throughout.

It should be understood that when an element or layer is referred to as being “on,” “adjacent to,” “connected to,” or “coupled to” other elements or layers, it can be directly on the other element or layer, adjacent thereto, connected or coupled to other elements or layers, or intervening elements or layers may be present. In contrast, when an element is referred to as being “directly on,” “directly adjacent to,” “directly connected to,” or “directly coupled to” other elements or layers, there are no intervening elements or layers present. It should be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below; and the apparatus may be otherwise oriented (e.g., rotated 90 degrees or at other orientations) and the spatially relative descriptors used herein interpreted accordingly.

The terminology used herein is for the purpose of describing particular embodiments and is not intended to be limiting of exemplary embodiments. As used herein, the singular forms, such as “a” and “an,” are intended to include the plural forms as well, unless the context clearly indicates otherwise. Additionally, the terms, “includes,” “including,” “comprises” and “comprising,” specify the presence of the stated elements or steps but do not preclude the presence or addition of one or more other elements or steps. As used herein, the term “and/or” includes any and all combinations of one or more of the associated listed items.

Example embodiments are described herein with reference to cross-section illustrations that are schematic illustrations of idealized, example embodiments (and intermediate structures). As such, variations from the shapes of the illustrations as a result, for example, of manufacturing techniques and/or tolerances, are to be expected. Example embodiments should not be construed as limited to the particular shapes of regions illustrated herein but are to include deviations in shapes that result, for example, from manufacturing. For example, an implanted region illustrated as a rectangle will, typically, may have rounded or curved features and/or a gradient of implant concentration at its edges rather than a binary change from implanted to non-implanted region. Likewise, a buried region formed by implantation may result in some implantation in the region between the buried region and the surface through which the implantation takes place. The regions illustrated in the figures are schematic in nature and their shapes are not intended to illustrate the actual shape of a region of a device and are not intended to limit the scope of example embodiments.

To understand the invention thoroughly, the following descriptions will be provided detail steps and structures so as to explain the technical solution for the invention. The preferred embodiment is described as follows. However, the invention has others further embodiments except for beyond the detailed description.

Along with the scale of the wafer extends to 300 mm, the inner diameter cutting machine has been replaced by a wire cutting machine, which is widely applied in the ingot slicing process. Wherein, the diamond wire cutting adopts depositing the diamond particles on the steel wire surface by the consolidation method to slice the ingot, in which the diamond particles are used as the grinding medium. The advantages of this method are the slicing efficiency is high and the diamond wire is reusable.

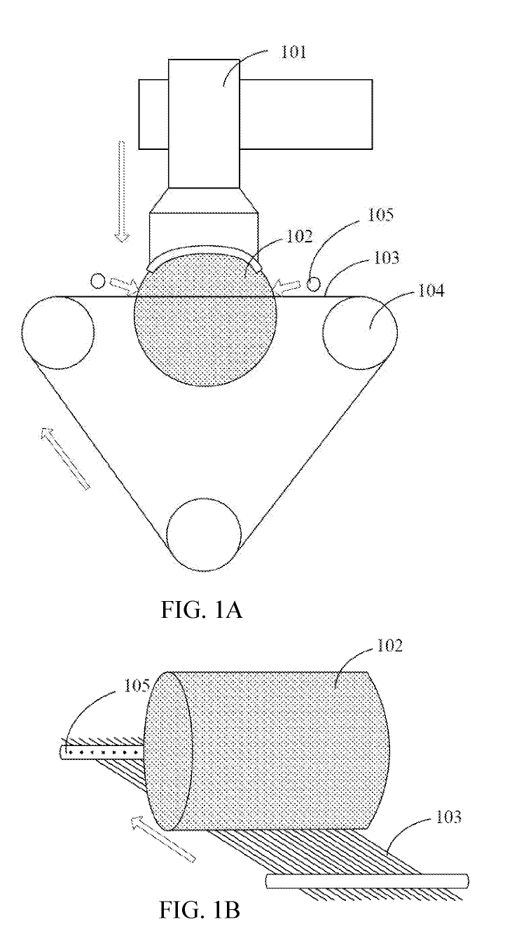

FIGS. 1A through 1B are schematic views illustrating a slicing method for an ingot according to one embodiment of the present disclosure. As shown in FIGS. 1A through 1B, an ingot-feeding device 101 drives an ingot 102 to be ascended or descended to implement the feeding of the ingot 102. Under the ingot-feeding device 101, a diamond wire 103 is formed a wire net on a main line roller through the guiding of a roller 104. Science the reciprocation of the diamond wire 103 produces a cutting action, the ingot 102 can be sliced to a plurality of wafers simultaneously; at the same time, under the action of a pressure pump, a cooling liquid nozzle 105 provided on the apparatus sprays a cooling liquid to a cutting portion of the diamond wire 103 and the ingot 102 to reduce heat from the diamond wire 103 and the ingot 102. However, since the severe rubbing between the diamond particles and the ingot during slicing, the temperature gradient between a slicing area and a non-slicing area of the ingot is larger, such that the warp the wafer is worse.

For the above-mentioned problems, the present disclosure provides a slicing method for an ingot, which comprises setting an ingot on an ingot-feeding device; descending the ingot by the ingot-feeding device and loosening a diamond wire synchronously such that the ingot is surrounded with the diamond wire; and tightening the diamond wire after the ingot is descended to a cooling tank to begin to slice the ingot.

In one aspect, loosening or tightening the diamond wire is controlled by a movement of a movable roller.

In another aspect, the method further comprises the step of wrapping a resin layer around the ingot.

In yet another aspect, in the process of slicing the resin layer, the slicing speed is increased gradually.

In still another aspect, at the beginning of slicing the resin layer, an intake port and a delivery port of the cooling tank are opened such that the cooling fluid is circulated in the cooling tank.

In still another aspect, at the beginning of slicing the ingot, the circulated speed of the cooling fluid in the cooling tank is increased.

The slicing method and the slicing apparatus for the ingot of the present disclosure could raise the slicing speed and reduce the temperature difference from a slicing area to a non-slicing area so that the wrap of a silicon chip is improved.

To understand the invention thoroughly, the following descriptions will be provided detail steps and structures so as to explain the technical solution for the invention. The preferred embodiment is described as follows. However, the invention has others further embodiments except for beyond the detailed description.

### Embodiment 1

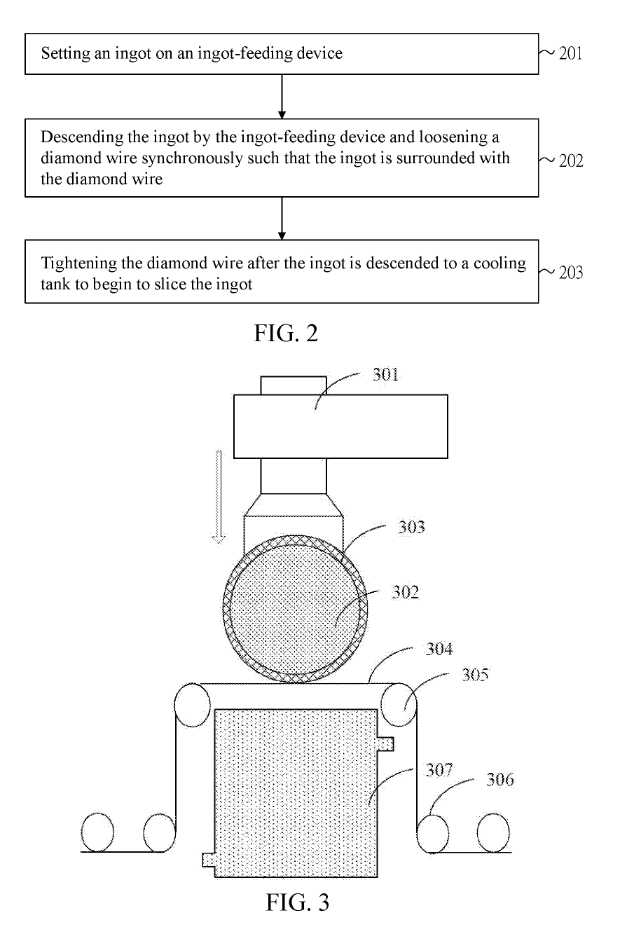

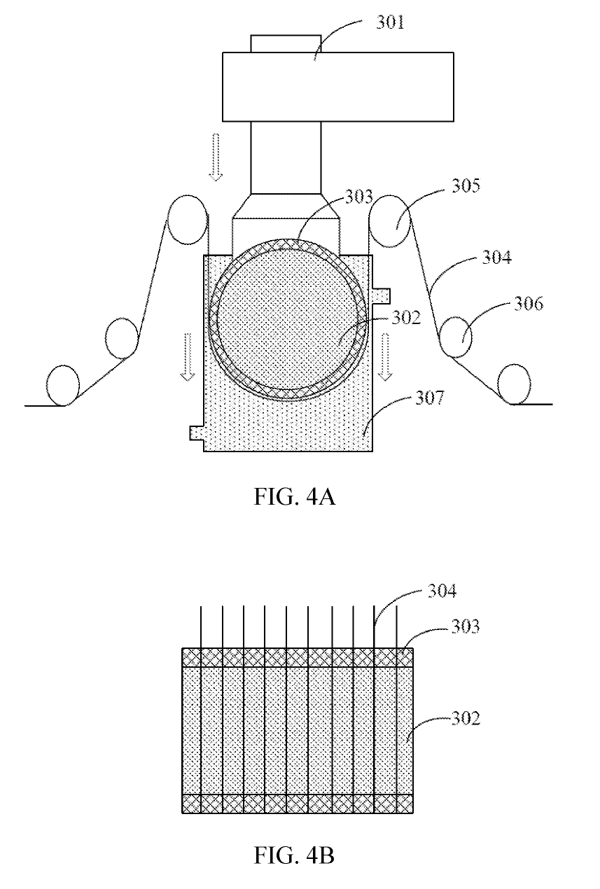

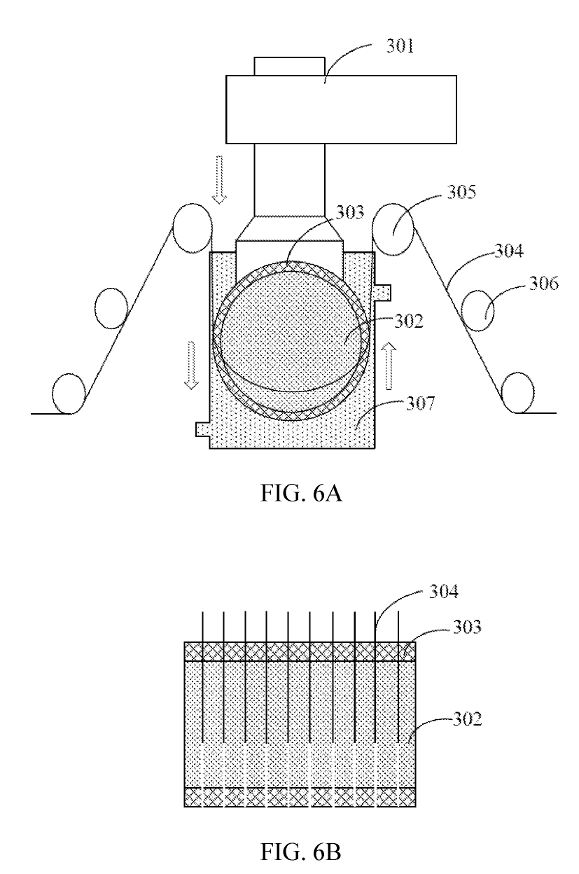

One exemplary embodiment of the slicing method for the ingot in the present disclosure will be described below with reference to FIG. 2 and FIGS. 3 through 6B.

First, performing step 201: an ingot 302 is set on an ingot-feeding device 301 as shown in FIG. 3.

Specifically, the ingot 302 is a monocrystalline silicon ingot. A brick can be formed in a casting furnace in advance, and then the brick is squared into the ingot 302 on a squaring machine.

In this embodiment, before the ingot 302 is setted on the ingot-feeding device 301, the surface of the ingot 302 is coated with and wrapped around with a resin layer 303, wherein the resin layer 303 coating on the ingot 302 can protect the ingot 302 from edge cracking or edge damage during following slicing process.

After the ingot 302 is wrapped with the resin layer 303, the ingot 302 is attached on a crystal support. The crystal support may be a graphite block, which has a surface with a circular arc the same with a diameter of the ingot 302. Afterward, the crystal support attached with the ingot 302 is installed on an ingot-feeding device 301.

Below the ingot-feeding device 301, a plurality of diamond wires 304 are provided perpendicularly to the ingot 302. The pluralities of diamond wires 304 are formed through depositing the diamond particles on the steel wire surface by the consolidation method to slice the ingot, in which the diamond particles are used as the grinding medium. Meanwhile, the movable roller 306 is positioned at the lowest position for tightening the pluralities of diamond wires 304, so that the pluralities of diamond wires 304 are immovable.

A cooling tank 307 is provided below the pluralities of diamond wires 304. Since there is no friction between the pluralities of diamond wires 304 and the ingot 302, the cooling tank 307 shouldn't proceed to cool and an intake thereof is under a closed state.

Afterward, step 202 is performed: the ingot 302 is descended by the ingot-feeding device 301 and loosening the pluralities of diamond wires 304 synchronously such that the ingot 302 is surrounded with the pluralities of diamond wires 304.

Specifically, the ingot-feeding device 301 controls the ingot 302 to be descended and gotten into the cooling tank 307 gradually, and the pluralities of diamond wires 304 are loosened by the movement of the movable roller 306, so that the lower portion of the ingot 302 is surrounded with the pluralities of diamond wires 304. At this time, the pluralities of diamond wires 304 and the ingot 302 are in contact with each other, and the friction is produced along with descending of the ingot 302. Because the friction is small at this time, the intake of the cooling tank 307 is still under a closed state.

Afterward, step 203 is performed: After the ingot 302 is descended into the cooling tank 307, the pluralities of diamond wires 304 are tightened to begin to slice the ingot 302.

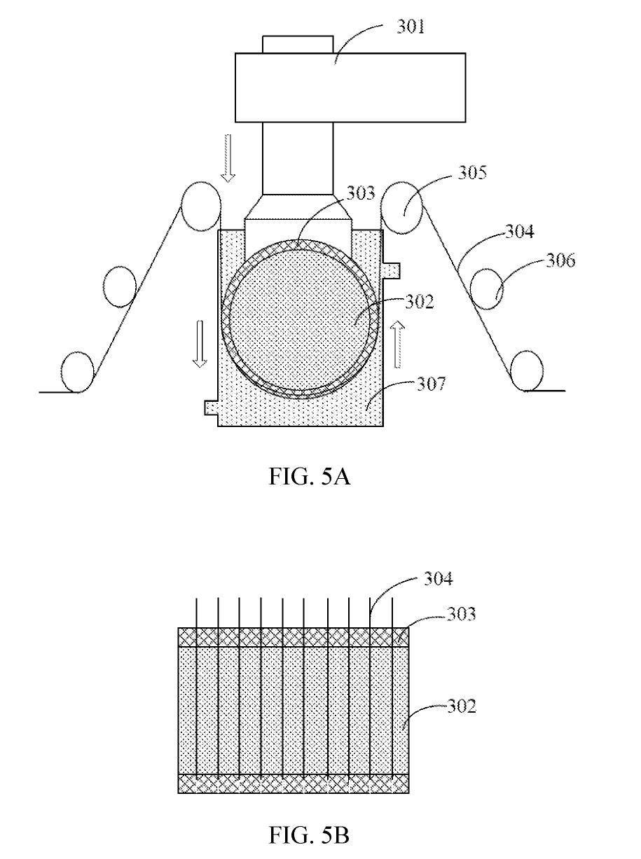

In this embodiment, first, the movable roller 306 is moved to a final position as shown in FIGS. 5A and 5B, so that the pluralities of diamond wires 304 are tightened again. A wire guiding 305 controls the pluralities of diamond wires 304 to move, and at the same time, the ingot-feeding device 301 controls the ingot 302 to be descended to begin to slice. Because the surface of the ingot 302 is wrapped with the resin layer 303, the resin layer 303 is cut first during slicing process to protect the ingot 302 from edge cracking or edge damage. At this time, the slicing is executed at low speeds, and the slicing speed is increased gradually in the process of slicing the resin layer 303.

When the slicing begins, the intake port and a delivery port of the cooling tank 307 are opened such that the cooling fluid is circulated in the cooling tank 307. The cooling fluid is such as water at about 20 degrees Celsius.

Along with the slicing is proceeded continuously, the slicing is entered to the stage of slicing the ingot 302. At this time, the slicing speed is increased at normal speeds. Because the ingot 302 is surrounded with the pluralities of diamond wires 304 before the slicing process, the contact surface of slicing has an arc shape, and that improves the slicing efficiency comparing with the contact surface of slicing belonging to a straight line. At this time, the ingot 302 is sunk in the cooling tank 307 completely, and the heat is taken off by fast circulated cooling fluid in the cooling tank 307, that can prevent from the temperature difference from a slicing area to a non-slicing area so that the wrap of a silicon chip is improved.

For example, since the slicing speed is faster during the processing of slicing the ingot 302, which may produce more heat, the flow of the cooling fluid of the intake of the cooling tank 307 could be enhanced after slicing the ingot 302 to raise the circulated speed of the cooling fluid and make sure the cooling effect of the ingot 302.

The steps of the slicing method for the ingot of this embodiment are described completely herein. It can be understood that the slicing method of this embodiment includes not only the above steps, but also other required steps before, during, or after the above steps, all of which are included in the scope of the method in this embodiment.

The slicing method for the ingot of the present disclosure could raise the slicing speed and reduce the temperature difference from a slicing area to a non-slicing area so that the wrap of a silicon chip is improved.

### Embodiment 2

Another exemplary embodiment of the slicing apparatus for the ingot in the present disclosure will be described below with reference to FIG. 3.

As shown in FIG. 3, the slicing apparatus includes: an ingot-feeding device 301 operable to control an ingot 302 to move in a vertical direction; a diamond wire 304 disposed below the ingot-feeding device 301 and provided with a movable roller 306 operable to control the diamond wire 304 to be loosened or tightened; and a cooling tank 307 disposed below the diamond wire 304 and operable to cooling the ingot 302 in the process of slicing the ingot 302. For example, the slicing apparatus further includes a wire guiding wheel 305 disposed above the cooling tank 307 and operable to control a reciprocal movement of the diamond wire 304.

For example, the slicing apparatus further includes a wire guiding wheel 305 disposed above the cooling tank 307 and operable to control a reciprocal movement of the diamond wire 304.

For example, the cooling tank 307 comprises an intake port at an under side thereof and a delivery port at a bottom side thereof.

The slicing apparatus for the ingot of the present disclosure could raise the slicing speed and reduce the temperature difference from a slicing area to a non-slicing area so that the wrap of a silicon chip is improved.

While various embodiments in accordance with the disclosed principles been described above, it should be understood that they are presented by way of example only, and are not limiting. Thus, the breadth and scope of exemplary embodiment(s) should not be limited by any of the above-described embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A slicing method for an ingot, comprising the steps of:
setting an ingot on an ingot-feeding device;
descending the ingot by the ingot-feeding device and loosening a diamond wire synchronously such that the ingot is surrounded with the diamond wire; and
tightening the diamond wire after the ingot is descended to a cooling tank to begin to slice the ingot.

2. The method according to claim 1, wherein loosening or tightening the diamond wire is controlled by a movement of a movable roller.

3. The method according to claim 1, further comprising the step of wrapping a resin layer around the ingot.

4. The method according to claim 3, wherein in the process of slicing the resin layer, the slicing speed is increased gradually.

5. The method according to claim 3, wherein at the beginning of slicing the resin layer, an intake port and a delivery port of the cooling tank are opened such that the cooling fluid is circulated in the cooling tank.

6. The method according to claim 5, wherein the circulated speed of the cooling fluid in the cooling tank is increased at the beginning of slicing the ingot.

7. A slicing apparatus for an ingot, comprising:
an ingot-feeding device operable to control an ingot to move in a vertical direction;
a diamond wire disposed below the ingot-feeding device and provided with a movable roller operable to control the diamond wire to be loosened or tightened; and
a cooling tank disposed below the diamond wire and operable to cooling the ingot in the process of slicing the ingot.

8. The apparatus according to claim 7, further comprising a wire guiding wheel disposed above the cooling tank and operable to control a reciprocal movement of the diamond wire.

9. The apparatus according to claim 7, wherein the cooling tank comprises an intake port at an under side thereof and a delivery port at a bottom side thereof.
